(19) United States
(12) Patent Application Publication
(10) Pub. No.: US 2014/0338178 A1
(43) Pub. Date: Nov. 20, 2014

(54) Method and Jaw Assembly for Applying End Fittings or Couplings to a Fluid Hose

(71) Applicants: Robert Bosch Tool Corporation, Broadview, IL (US); Robert Bosch GmbH, Stuttgart (DE)

(72) Inventors: Charles A. Lehmann, Metamora, IL (US); Tim Orow, Peoria, IL (US); Robert Richard Brimble, Edwards, IL (US)

(73) Assignees: Robert Bosch Tool Corporation, Broadview, IL (US); Robert Bosch GmbH, Stuttgart (DE)

(21) Appl. No.: 14/261,515

(22) Filed: Apr. 25, 2014

Related U.S. Application Data
(60) Provisional application No. 61/816,603, filed on Apr. 26, 2013.

(51) Int. Cl. B25B 27/10

(52) U.S. Cl. CPC B25B 27/10
USPC 29/450; 29/237

(57) ABSTRACT

An expansion jaw assembly for use in expanding an end fitting within a fluid hose comprises a plurality of elongated jaw elements configured when combined to form a cylindrical body sized for introduction into the interior of the end fitting. The jaw elements when combined define a tapered bore for receiving an expansion pin to move the jaw elements radially apart relative to each other, to thereby expand the diameter of the combined jaw elements within the end fitting. Each jaw element includes a plurality of rib segments projecting from an outer surface of the jaw element, the rib segments spaced along the length of the jaw element. The rib segments are defined by a radially outermost plateau, a fillet radius from the plateau to the outer surface of the jaw element.

### REFERENCE TO RELATED APPLICATION AND PRIORITY CLAIM

This application is a utility filing of and claims priority to provisional application No. 61/816,603, filed on Apr. 26, 2013, the disclosure of which is incorporated herein in its entirety.

### BACKGROUND

Typical hose couplings are shown in FIGS. 1a,-1c. As illustrated, a ferrule 10 is slipped over the end of the hose H and the shank 14 of the male (FIG. 1a) or the shank of the female (FIG. 1b) hose fitting 18 is inserted through the ferrule hole 11, into the inner diameter of the hose up to the formed shoulder 15. The male assembly of FIG. 1a terminates in an externally threaded end 12, while the female assembly of FIG. 1b terminates in a female end 13 that is curled upward 13′ to engage a coupling nut 16, as shown in FIG. 1c.

With the ferrule 10 positioned on the outside of the hose H and the shank 14 on the inside of the hose, a sectioned jaw tool 20, shown in FIG. 2a, is inserted into the shank. A tapered pin 22 is then inserted into the inner diameter of the jaws to expand the jaw elements 21 radially outward, thereby expanding the shank outward into the hose. The jaw elements are pivotably held together at one end by O-rings. The jaw elements 22 include expansion profiles or ridges 25, 26 that complement the ribs 10a (FIGS. 1b, 1c) stamped into the ferrule. Thus, the expansion of the jaw tool 20 forms grooves 27 in the shank 14 and compresses the hose into the grooves 10a of the ferrule 10, as shown in FIGS. 3-4.

The degree to which the shank must be expanded is determined by the thickness and the composition of the hose wall. With thinner, denser hose walls, the shank does not have to be expanded to as great an extent as a thick soft walled hose, as illustrated in FIG. 3. On the other hand, less dense, thicker hose walls require greater expansion of the shank, as depicted in FIG. 4. The amount of expansion can be expressed in terms of the height of the grooves 27 formed in the shank. For the more dense hose material the expansion can be denoted as X % of the shank diameter, while the less dense material expands Y % of the shank diameter, where X is greater than Y.

The hose industry has used brass as a coupling material for many years. Brass coil stock is ductile enough to be easily formed with progressive dies and rolling tools for beading and threading. Once these forms are made they are still ductile enough for assembly. With the use of brass, the expansion required for X % or Y % diameter increase has been achievable. However, problems occur when less ductile materials are used and the problems are particularly more pronounced when a less dense, thicker walled hose is used. Another aspect of brass ferrules is that the ferrule 10 itself can expand when the shank 14 is expanded due to the ductility of the brass. For ferrules formed of less ductile material the expansion is very minimal, if at all.

In spite of these disadvantages, the use of less ductile materials offers various benefits over the more ductile materials (brass) that are presently used in hose couplings. For instance, less ductile materials are stronger and more crush resistant that the ductile materials. In most cases the less ductile material is less expensive.

### SUMMARY OF THE DISCLOSURE

A method for engaging an end fitting to a fluid hose that includes mounting a compression ring around one end of the fluid hose and inserting the shank of the hollow end fitting into the interior of the fluid hose in radial alignment with the compression ring. In one aspect, the shank and the compression ring are formed of a low-ductility radially expandable material, such as a stainless steel. A conventional expansion tool or pin is inserted into the interior of the end fitting with the expansion surface of the expansion tool radially aligned with the compression ring. The compression ring is engaged with a conventional external circumferential compression tool. In accordance with the present disclosure, the method includes simultaneously expanding the expansion tool within the end fitting to expand the shank of the end fitting into the fluid hose, and actuating the compression tool to compress the compression ring into the fluid hose.

In a further aspect, an expansion jaw assembly for use in expanding an end fitting within a fluid hose comprises a plurality of elongated jaw elements configured when combined to form a cylindrical body sized for introduction into the interior of the end fitting. The jaw elements when combined define a tapered bore for receiving an expansion pin to move the jaw elements radially apart relative to each other, to thereby expand the diameter of the combined jaw elements within the end fitting. Each jaw element includes a plurality of rib segments projecting from an outer surface of the jaw element, the rib segments spaced along the length of the jaw element. The rib segments are defined by a radially outermost plateau, a fillet radius from the plateau to the outer surface of the jaw element.

### DESCRIPTION OF THE FIGURES

FIGS. 1a, 1b, 1c are side cross-sectional views of conventional hose coupling components of the prior art.

FIGS. 2a, 2b, 2c are views of an expansion jaw assembly of the prior art used to engage hose coupling components, such as the components in FIGS. 1a-c, to a hose, including a perspective view of the tool and enlarged detail views of the profile of jaws of the assembly.

FIG. 3 is a side cross-sectional view of the crimped engagement of the hose coupling components shown in FIG. 1a to a dense, thin-walled hose.

FIG. 4 is a side cross-sectional view of the crimped engagement of the hose coupling components shown in FIG. 1a to a less dense, thick-walled hose.

FIG. 5 is a side view of the coupling components according to one aspect of the present disclosure.

FIG. 6 is a side cross-sectional view of the coupling components shown in FIG. 5 engaged to a hose.

FIG. 7 is a side cross-sectional view of the coupling components shown in FIG. 5 engaged to a hose showing the amount of compression and expansion applied to the components.

FIG. 8 is an enlarged view of the shank of a coupling component exhibiting stress fractures under expansion forces.

FIG. 9 is an enlarged view of the shank of a coupling component exhibiting stress fractures under expansion forces

FIG. 10 is a perspective view of an expansion jaw assembly according to one aspect of the present disclosure.

FIG. 11 is a side view of the expansion jaw assembly shown in FIG. 10.

FIG. 12 is a cross-sectional view of the expansion jaw assembly shown in FIG. 10.

FIG. 13 is an end view of the expansion jaw assembly shown in FIG. 10

FIG. 14 is an enlarged detail view of the rib segments for the jaw elements of the expansion jaw assembly shown in FIG. 10.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

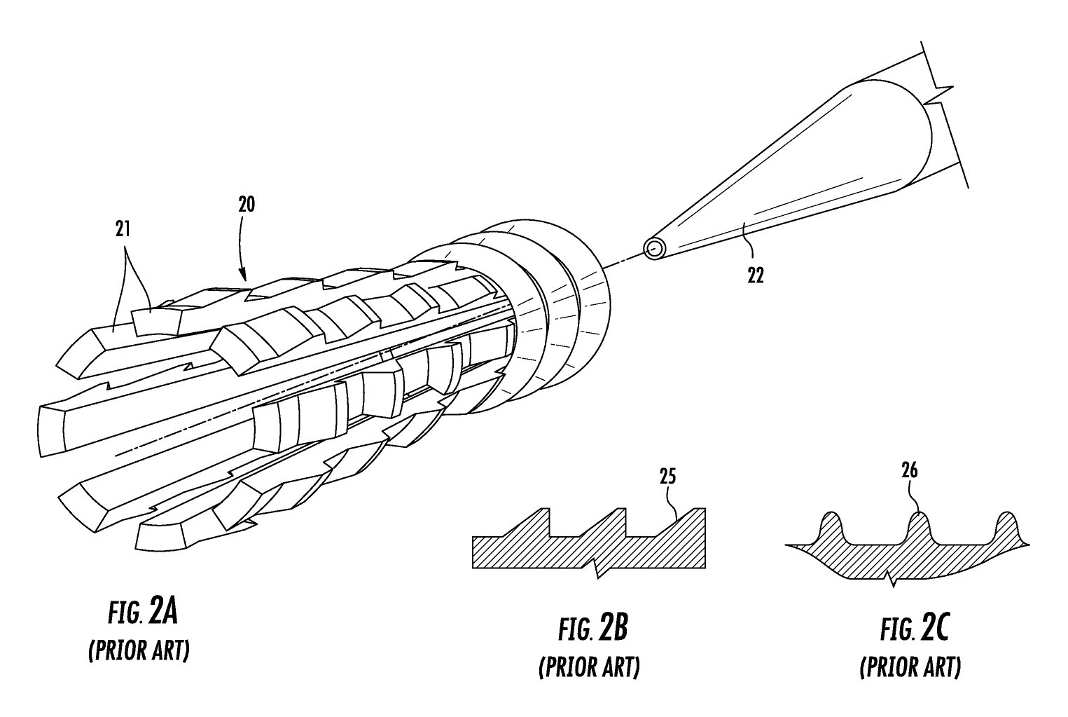

The present disclosure contemplates forming the hose coupling components of a less ductile material, such as stainless steel or plated/coated steel, or other materials of similar ductility. When the standard shaped expanding jaws (jaw assembly 20 of FIG. 2a) and the normal insertion speed of the tapered pin (pin 22) into the jaws are used, a shank formed of a less ductile material is prone to cracking or splitting in two different directions. This problem is even more pronounced with the thicker, less dense walled hose.

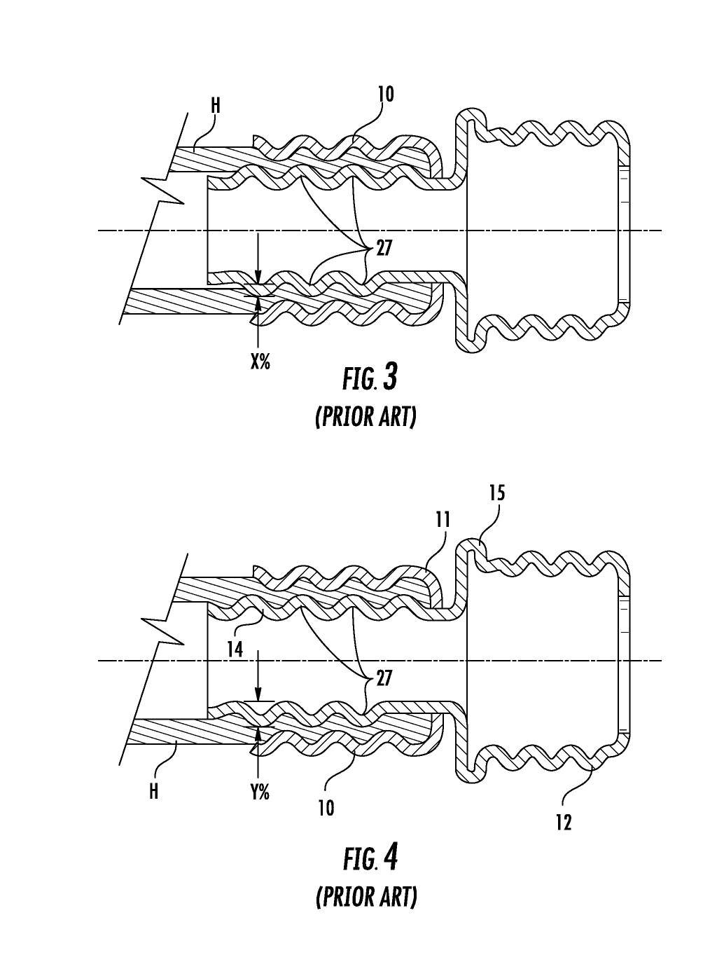

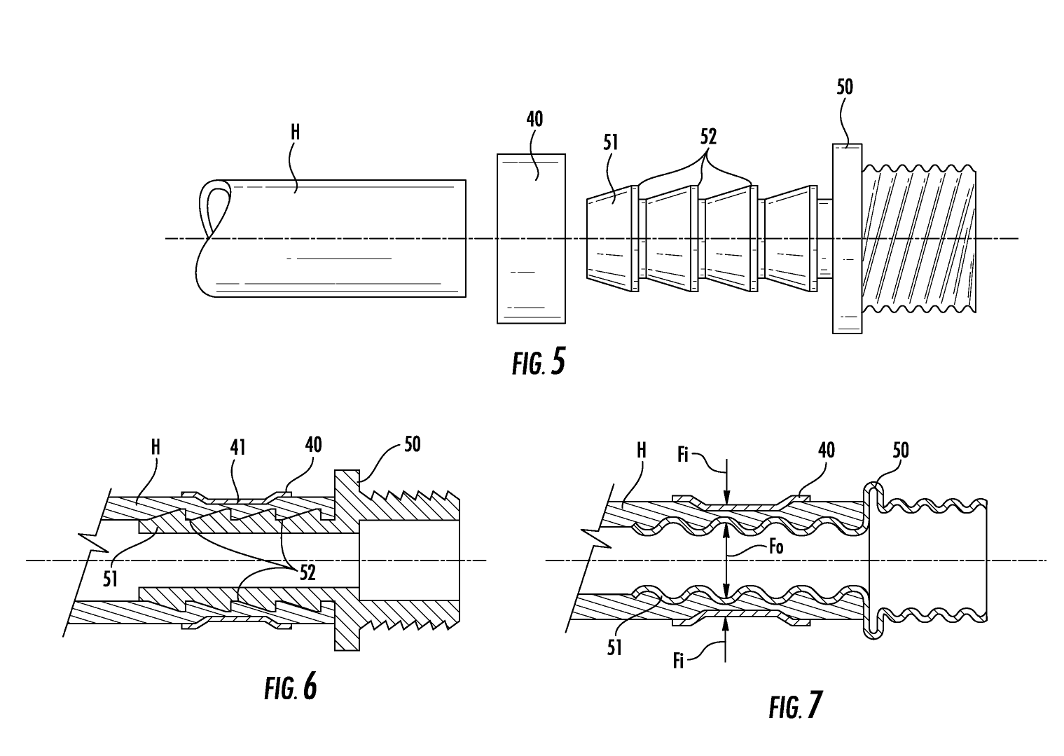

With the standard practice, the shank 14 is the part experiencing the greatest amount of expansion since the expanding jaws apply force only to the inside of the shank. To reduce the amount of expansion of the shank, the present disclosure contemplates applying force to the components in two directions at the same time, namely radially outward and radially inward. In some applications the shank may be a ridged structure with ridges on the outside of the shank. For instance, as shown in FIGS. 5-6 a less ductile metal (i.e., steel) compression ring 40 is placed on hose H. A metal shank 51 of the coupling or fitting 50 is inserted into inner diameter of the hose. The shank 51 may include ridges 52 to enhance engagement with the hose. In one aspect, the compression ring 40 is deformed inward by a force Fi at a middle portion 41 of the ring, as illustrated in FIGS. 6-7, to compress the hose H against the ridges 52. The compressive or crimping force Fi may be applied using a conventional crimping ring tool that provides a compressive force around the entire circumference. At the same time, the expanding jaw assembly 20 may be used at the inner diameter of the shank 51 to apply a radially outward force Fo. This allows the inner and outer components (the ring 40 and the shank 51) to be deformed about half as much as if the expansion force were applied to a single part. Limiting the deformation of the less ductile material reduces the risk that the components will crack or split. Thus, for a thin-walled hose of FIG. 6, the expansion of X % (see FIG. 3) can be half (X/2%) for both the ring and the shank. Similarly, for the thick-walled hose of FIG. 7 the expansion can be also be half (Y/2%) for the two components.

Thus, the present disclosure contemplates a method for engaging an end fitting to a fluid hose that includes mounting a compression ring around one end of the fluid hose and inserting the shank of the hollow end fitting into the interior of the fluid hose in radial alignment with the compression ring. In one aspect, the shank and the compression ring are formed of a low-ductility radially expandable material, such as a stainless steel. A conventional expansion tool or pin is inserted into the interior of the end fitting with the expansion surface of the expansion tool radially aligned with the compression ring. The compression ring is engaged with a conventional external circumferential compression tool. In accordance with the present disclosure, the method includes simultaneously expanding the expansion tool within the end fitting to expand the shank of the end fitting into the fluid hose, and actuating the compression tool to compress the compression ring into the fluid hose

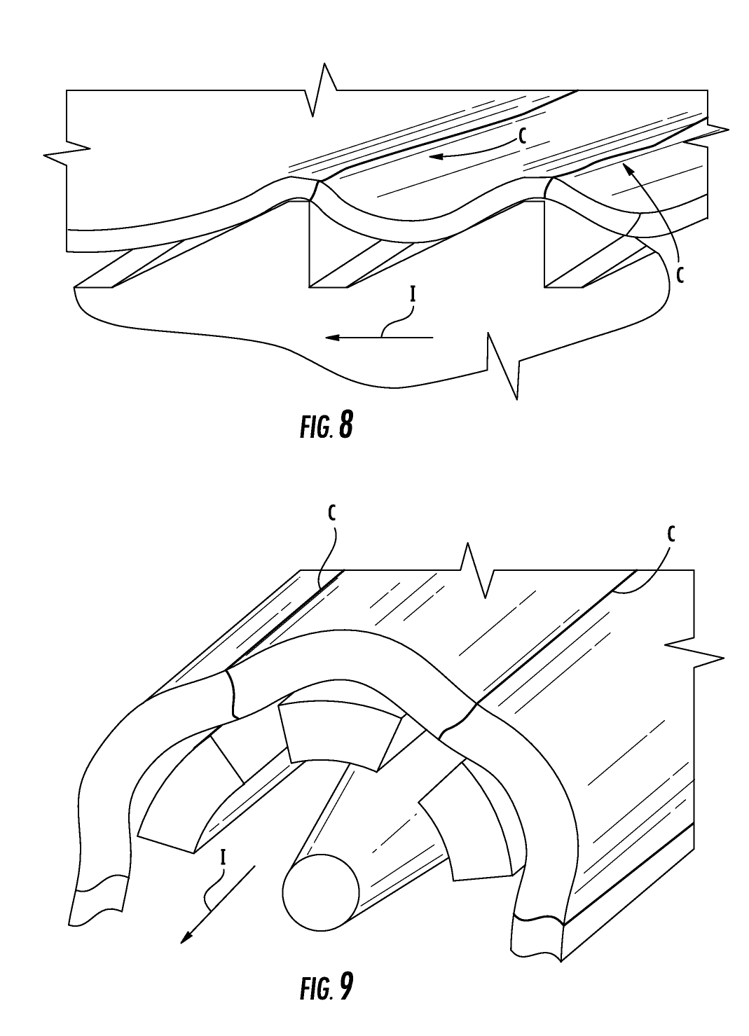

Typical jaws have expansion profiles 25, 26 that have relatively sharp corners, as illustrated in FIGS. 2b, 2c. The sharp corners on the conventional expanding jaws cause stress cracks as illustrated in FIGS. 8 and 9. Thus, cracks can form and propagate in a direction C perpendicular to the insertion direction I of the expanding jaws (FIG. 8) and parallel to the insertion direction (FIG. 9) as the jaws are expanded. As the jaws are expanded radially outward, the less ductile material cannot expand quickly enough, leading to the formation of cracks. For a plated or coated material, if the expansion is too rapid the coating can separate or flake away, which exposes the coupling component to corrosion.

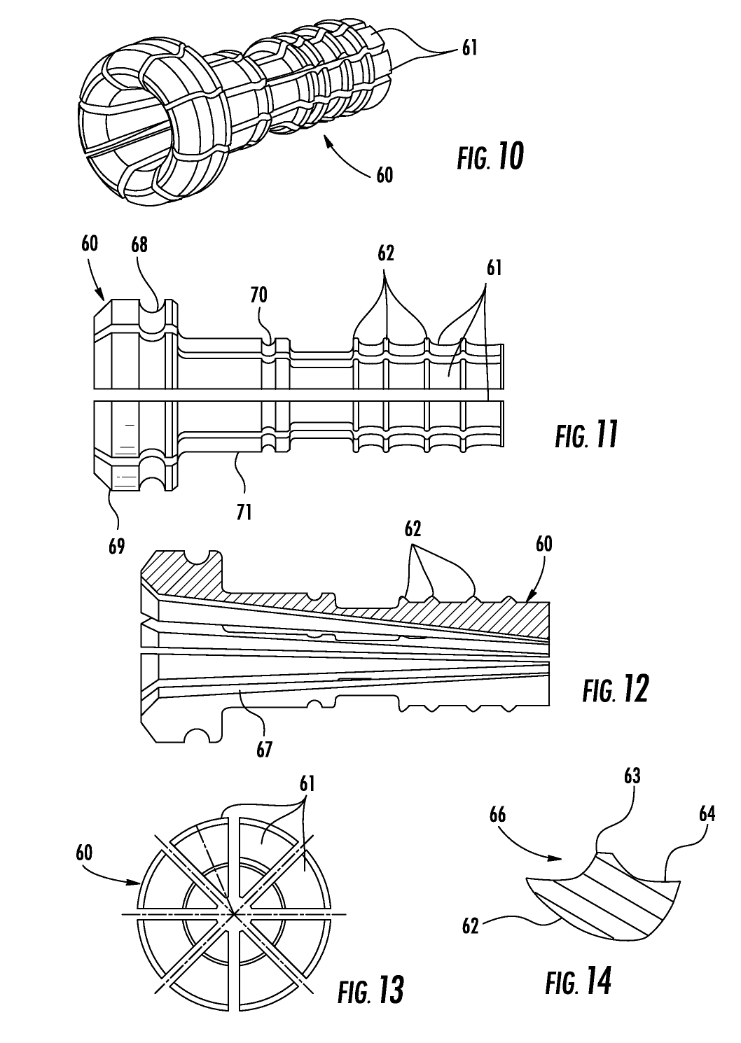

In order to overcome this problem when using less ductile material for the hose coupling components, the present disclosure contemplates reducing the insertion speed of the pin 22 into the jaw assembly, such as assembly 20, to more gradually expand the jaw assembly and ultimately to more gradually deform the shank of the fitting. In addition, the present disclosure contemplates modifying the expanding jaw assembly as shown in FIGS. 10-14. The expansion jaw assembly 60 of FIG. 10 includes jaw elements 61 each having circumferential rib segments 62 formed along the length of their outer surface. The jaw elements are configured when combined to form a generally cylindrical body sized for insertion into the end fitting 50. Moreover, when combined the circumferential rib segments 62 of the jaw elements form a generally continuous circumferential rib prior to expansion of the jaw assembly.

In one aspect of the present disclosure, the rib segments are rounded to eliminate the sharp corners of the prior jaw designs. As shown in the detail view of FIG. 14, the rib segments 62 have a narrow plateau 63 flanked by rounded corners 64. The rounded corners merge into the body of the jaw 61 at a radius 65 in the nature of a fillet radius. Thus, rather than presenting abrupt sharp corners and edges to the coupling components, as with the prior expansion profiles 25, 26, the expansion profile of the rib segments 62 shown in FIG. 14 provides a more gradual surface for contacting the less ductile material. In a specific embodiment, the plateau 63 has a width of about 0.028 in. and a radius 66 is about 0.059 in. The transition from the fillet radius 66 to the plateau 63 can have a radius of about 0.016 in. In the embodiment depicted in FIGS. 10-13, the expansion jaw assembly 60 includes seven jaw elements uniformly spaced around the circumference at 45° intervals. In the illustrated embodiment, the jaw elements 61 each include four ribs 62 that span the angular extent of the jaw.

The jaw assembly 60 defines a tapered bore 67 therethrough adapted to engage an expansion tool, such as the tapered pin 22 shown in FIG. 2a. The tapered bore may be defined at an angle of 5 degrees. Each jaw element may include a circumferential groove 68 on the exterior of an enlarged head portion 69 of the jaw element 61 and a groove 70 on a shank portion 71 of the jaw element. The grooves 68, 70 are configured to receive an elastic O-ring to hold the separate jaw elements 61 together in a conventional manner. The O-rings also provide elastic resistance to expansion of the jaw assembly 60 during insertion of the pin 22.

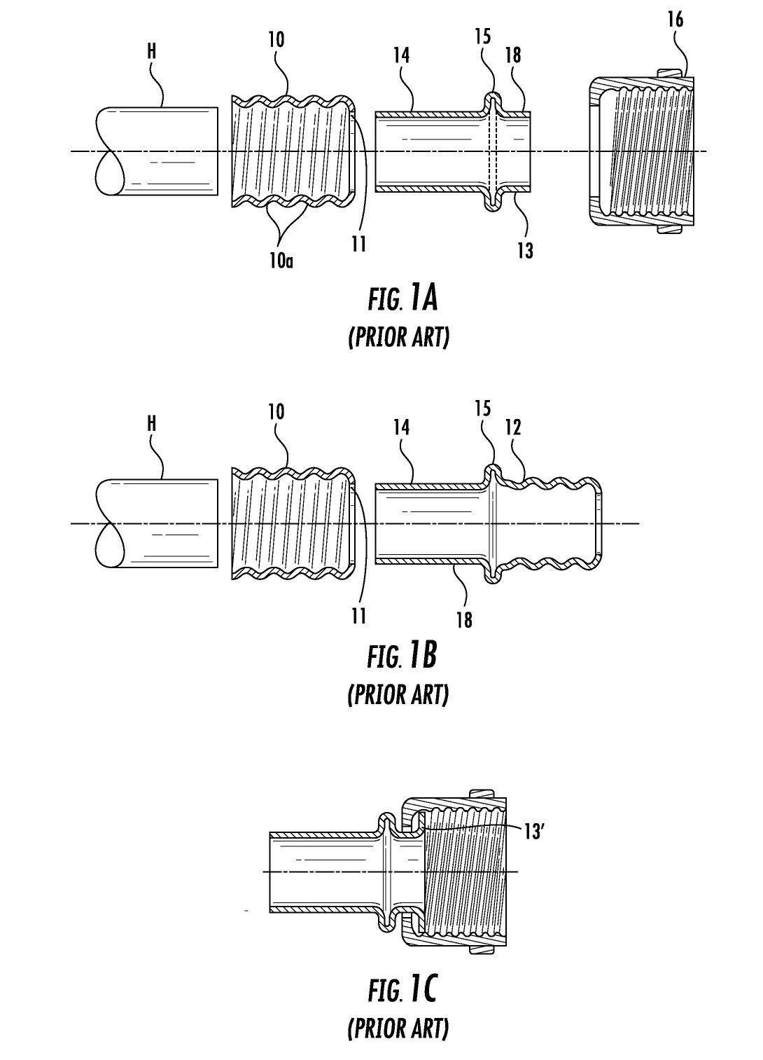

The benefits of the modified expansion profiles are demonstrated by stress analysis of the shank 14 (FIG. 1) or 51 (FIG. 7) of a corresponding fitting 18, 50. Stress analysis of an expansion force applied by an expansion jaw having a conventional profile, such as the profile 25 (FIG. 2b), produces a maximum principal stress of 7.93 N/mm² at a maximum radial displacement of 3.562e⁻⁰⁶ mm of the shank. On the other hand, the modified profile 62 shown in FIG. 14b results in a comparable maximum principal stress of 8.622 N/mm² at a much greater maximum radial deformation of the shank as high as 9.32e⁻⁰⁵ mm. Thus, the modified profile of the rib segments 62 permits about 25 times greater radial expansion than the conventional expansion rib profile. At a radial expansion comparable to the conventional rib design (i.e., at a radial deformation of 3.5e⁻⁰⁶ mm) the stress experienced by the shank of the fitting is considerably less (in the range of about 2 N/mm²) and well below the fatigue level of the less ductile material of the fitting shank 14, 51.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A method for engaging an end fitting to a fluid hose comprising:
mounting a compression ring around one end of the fluid hose;
inserting the shank of a hollow end fitting into the interior of the fluid hose in radial alignment with the compression ring, the shank formed of a low-ductility radially expandable material;
inserting an expansion tool into the interior of the end fitting with the expansion surface of the expansion tool radially aligned with the compression ring;
engaging the compression ring with an external circumferential compression tool; and
simultaneously expanding the expansion tool within the end fitting to expand the shank of the end fitting into the fluid hose and actuating the compression tool to compress the compression ring into the fluid hose.

2. The method of claim 1, wherein the compression ring is formed of a low-ductility material.

3. The method of claim 2, wherein the low-ductility material is a stainless steel.

4. An expansion jaw assembly for use in expanding an end fitting within a fluid hose comprising:
a plurality of elongated jaw elements configured when combined to form a cylindrical body sized for introduction into the interior of the end fitting;
the jaw elements when combined defining a tapered bore for receiving an expansion pin to move the jaw elements radially apart relative to each other, to thereby expand the diameter of the combined jaw elements within the end fitting; and
each jaw element including a plurality of rib segments projecting from an outer surface of the jaw element, the rib segments spaced along the length of the jaw element and defined by a radially outermost plateau and a fillet radius from the plateau to the outer surface of the jaw element.

5. The expansion jaw assembly of claim 4, wherein the plateau has a width of about 0.028 in. along the length of each jaw element and the fillet radius is about 0.059 in.

6. The expansion jaw assembly of claim 4, wherein each rib segment includes a transition radius from the fillet radius to the plateau of about 0.016 in.

7. The expansion jaw assembly of claim 4 wherein the plurality of jaw elements includes seven jaws uniformly spaced around a circumference at 45° intervals.

8. The expansion jaw assembly of claim 4, wherein each jaw element includes a shank portion including said plurality of rib segments and an enlarged head portion integral with said shank portion, said head portion defining a circumferential groove configured to receive an elastic O-ring when the jaw elements are combined.

9. The expansion jaw assembly of claim 8, wherein the shank portion defines a second circumferential groove between the first circumferential groove and the rib segments, configured to receive an elastic O-ring when the jaw elements are combined.
